(19) United States
(12) Patent Application Publication
(10) Pub. No.: US 2009/0086381 A1
(43) Pub. Date: Apr. 2, 2009

(54) MANUFACTURING METHOD OF THIN-FILM MAGNETIC HEAD WITH DISHING SUPPRESSED DURING POLISHING

(75) Inventors: Tetsuya HIRAKI, Tokyo (JP); Seiji YARI, Tokyo (JP); Yasufumi UNO, Tokyo (JP); Hideaki SATO, Tokyo (JP); Takahide MASUDA, Tokyo (JP); Kazuhiro KOBAYASHI, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 11/865,405

(22) Filed: Oct. 1, 2007

(51) Int. Cl. G11B 5/33

(52) U.S. Cl. 360/319

(57) ABSTRACT

A manufacturing method of a thin-film magnetic head with a dishing suppressed in the case of planarizing a magnetic shield which a read head portion has or a magnetic pole which a write head portion has is provided. A manufacturing method of a thin-film magnetic head comprising a read head portion for data reading which has at least two magnetic layers functioning as a magnetic shield and a write head portion for data writing which has two magnetic layers functioning as a magnetic pole is provided, in a process forming at least the lowest magnetic layer in at least the two magnetic layers functioning as the magnetic shield and the two magnetic layers functioning as the magnetic pole in the case of forming a plurality of thin-film magnetic head patterns on an element formation surface of the wafer substrate, which comprises steps of: forming this magnetic layer so as to reach a position which becomes a medium opposed surface at a middle portion to a trick width direction in each thin-film magnetic head pattern, and forming a dishing prevention portion at a position farther than this magnetic layer from the position which becomes the medium opposed surface in both sides or either side along the track width direction of this magnetic layer; forming a nonmagnetic insulating layer so as to cover the magnetic layer and the dishing prevention portion; and planarizing and polishing the magnetic layer, the dishing prevention portion, and the nonmagnetic insulating layer thereafter.

### BACKGROUND OF THE INVENTION

1. Field of the Invention

The present invention relates to a manufacturing method of a thin-film magnetic head, in particular, relates to a manufacturing method with a dishing suppressed during a polishing for planarization. Further, the present invention relates to the thin-film magnetic head manufactured by this method.

2. Description of the Related Art

Recently, in a magnetic recording/reproducing apparatus, high capacity of saved data makes remarkable advance by growth of multimedia or Internet so on. This situation is a same as, for example, a magnetic tape apparatus for data backup or data saving, therefore a high recording density and a multi channel corresponding to the high capacity of saved data are strongly demanded.

A thin-film magnetic head is widely used in such magnetic recording/reproducing apparatus, it makes data writing to a magnetic recording medium and data reading from the magnetic recording medium. In the thin-film magnetic head, a downsizing and a high performance corresponding to the high capacity of saved data are also strongly demanded. For example, in the thin-film magnetic head (a tape head) for the magnetic tape apparatus, for allowing to read and write data to a large tracks, a read head portion and a write head portion are provide, which many elements are arranged along the track width direction. As a result, the tape head corresponding to this multi channel is, generally, a small size in response to the high density recording, but has a long and thin rectangle shape.

There are two types of the manufacturing method of this tape head. The one is a full span type to form all of the head configuration on a wafer substrate, the other is a chiplet type to form only the write head portion and the read head portion on a wafer substrate, then to complete the head configuration by pasting others parts. In the manufacturing method of the chiplet type, it is difficult to maintain a pasting accuracy during pasting the others parts, but the full span type does not have this difficulty and widely used.

However, in the manufacturing method of the full span type, especially, a dishing to occur in a planarization process of a shield becomes a problem. The dishing is a phenomenon to be formed a dished area in the wafer substrate in the case of using a chemical mechanical polishing (CMP) in this planarization process. As a polishing rate with the CMP is different each material exposing on a polishing surface, the dishing occurs by reason that the polishing rate is different each place by distribution of the exposing material on an exposed surface. In the manufacturing method of the full span type, especially, the degree of the coarseness and minuteness of the head pattern is large, then the dishing becomes the problem.

Specifically, this forms and arranges a plurality of shields which consist of a magnetic material by a predetermine pitch as the read head portion and the write head portion, and then stacks a nonmagnetic insulating layer so as to cover a plurality of shields, and performs the planarization with the CMP. In this case, the dishing is hard to occur in the a plurality of shields areas, but at vicinity of both end portions along the track width direction in each long and thin rectangle shaped head pattern, any pattern is not formed, therefore the dishing is easy to occur because the nonmagnetic insulating layer is mainly polished. The place to occur the dishing is usually a place to be formed a electrode pad such as a RLG pad, for example, this causes a defect such that an upper surface of the formed electrode pad tilts toward the element formation surface of the wafer substrate.

Further, in a plurality of shield areas, the distribution about a layer thickness of the shield can occur. That is to say, the phenomenon that the layer thickness is small can occur at vicinity of the both end portions along the track width direction in an arrangement of a plurality of shields with covering a hem of the dishing. Especially, in subsequent process, an magnetoresistive (MR) effect multilayer which is a magneto-sensitive portion is formed on a plurality of lower shields, but if the layer thickness of the lower shield has the distribution, a focus exposure toward a resist layer using for forming the MR effect multilayer be distributed, then it is difficult to realize the most suitable exposure at all positions on a plurality of lower shields. This can reduce a yield ratio. Further, as such distribution of the layer thickness occurs by not only the planarization of the lower shield but also the planarization of the upper shield on it and the magnetic layer which the write head portion has, the distribution is stacked as layers is stacked.

Further, generally, it is found that the degree of the distribution changes each time. Therefore, for example, providing a maker for measuring the layer thickness at a position far from the arrangement of a plurality of lower shields, if the layer thickness of the nonmagnetic insulating layer is managed at the maker position and then the layer thickness of the lower shield is adjusted, it is difficult to manage the distribution of the layer thickness of the lower shield.

A method for solving a difference of the layer thickness of the layer remained after the CMP is disclosed in, for example, Japanese Patent Publication No. 2003-140319A, and this is a technique equalizing a pattern density by inserting, for example, a regular rectangle dummy pattern in an area except for real pattern in a mask, which is the mask for manufacturing a semiconductor element. Further, for example, in Japanese Patent Publication No. 2002-198419A is disclosed a technique forming the dummy pattern laid out by a plurality of trenches on a substrate, which is a semiconductor substrate, on this occasion, considering a occupation density of the dummy pattern, and a occupation density and a figure of non polishing film, then performing the CMP.

However, it is very difficult to apply these conventional arts in semiconductor field to a planarization process manufacturing the tape head. In other words, for example, in the case of planarizing and forming the shield, if the pattern is formed to control the pattern density in the mask, many ferromagnetic material patterns are formed at a portion except for the shield. These ferromagnetic material patterns frequently reduce head resistance property against external magnetic field, especially, the ferromagnetic material patterns at vicinity of a medium opposed surface that is a head end surface of the magnetic tape side bring the magnetic tape unnecessary magnetic field. Therefore, it is understood that it is not preferable to form the dummy pattern such that the pattern density is constant.

### BRIEF SUMMARY OF THE INVENTION

Therefore, it is an object of the present invention to provide a manufacturing method of a thin-film magnetic head with a dishing suppressed during a polishing in the case of planarizing a shield which a read head portion has or a magnetic pole layer which a write head portion has.

Further, it is an object of the present invention to provide a thin-film magnetic head without a bad effect due to the dishing.

Here, some terms will be defined before explaining the present invention. In a layered structure of the thin-film magnetic head formed on an element-formed surface of the slider substrate, a component that is closer to the element-formed surface than a standard layer is defined to be “below” or “lower” in relation to the standard layer, and a component that is in the stacking direction side (a opposite direction to the substrate) of the standard layer is defined to be “above” or “upper” in relation to the standard layer.

According to the present invention, a manufacturing method of a thin-film magnetic head comprising a read head portion for data reading which has at least two magnetic layers functioning as a magnetic shield and a write head portion for data writing which has two magnetic layers functioning as a magnetic pole is provided, in a process forming at least the lowest magnetic layer in at least the two magnetic layers functioning as the magnetic shield and the two magnetic layers functioning as the magnetic pole in the case of forming a plurality of thin-film magnetic head patterns on an element formation surface of the wafer substrate, which comprises steps of: forming this magnetic layer so as to reach a position which becomes a medium opposed surface at a middle portion along a trick width direction, and forming a dishing prevention portion at a position farther than this magnetic layer from the position which becomes the medium opposed surface in both sides or either side along the track width direction of this magnetic layer, in each thin-film magnetic head pattern; forming a nonmagnetic insulating layer so as to cover the magnetic layer and the dishing prevention portion; and planarizing and polishing the magnetic layer, the dishing prevention portion, and the nonmagnetic insulating layer thereafter.

In the manufacturing method of the thin-film magnetic head according to the present invention, in the case of planarizing the magnetic layer and the nonmagnetic insulating layer by the polishing, in one head pattern, the dishing prevention portion is formed at the position farther than this magnetic layer from a position which becomes the medium opposed surface in both sides or either side along the track width direction of this magnetic layer. Therefore, the dishing rate becomes almost uniform because the magnetic layer and the dishing prevention portion are distributed uniformly at predetermined ratio in whole element formation surface of the wafer substrate formed a plurality of head patterns. As a result, it is possible to suppress the dishing. Here, it is preferable that the magnetic layer and the dishing prevention portion are formed of a same magnetic material.

Further, it is also preferable that a manufacturing method of a thin-film magnetic head comprising a read head portion which has a plurality of pairs of a lower shield and an upper shield functioning as a magnetic shield and a write head portion which is formed above this read head portion and has a plurality of pairs of a lower magnetic pole layer and an upper magnetic pole layer functioning as a magnetic pole comprises a step of: forming the dishing prevention portion at the position farther than a plurality of lower shields from the position which becomes the medium opposed surface in both sides or either side along the track width direction of a plurality of lower shield in the case of forming at least a plurality of lower shield among a plurality of lower shields, a plurality of upper shields, and a plurality of lower magnetic pole layers.

In this manufacturing method, it is also preferable that a plurality of lower shields and the dishing prevention portion are formed of soft magnetic material such as sendust or NiFe (permalloy), amorphous soft magnetic material such as CoZrTa, or soft magnetic material which consists primarily of these material, and the nonmagnetic insulating layer is formed of alumina, and a plurality of lower shields, the dishing prevention portion and the nonmagnetic insulating layer are polished and planarized by a chemical mechanical polishing. Further, it is also preferable that at least one electrode is formed immediately above the dishing prevention portion. When the electrode is formed as above, a pad of the electrode is almost parallel to the element formation surface of the wafer substrate. As a result, when a probe contacts to the pad, a stable and higher reliability contact is possible. And, when the pad fixes to a lead, a stable and higher reliability fixing is also possible.

Further, it is also preferable that the dishing prevention portion is formed by sequentially stacking a plurality of dishing prevention layers via or not via the nonmagnetic insulating layer. Further, in this case, it is also preferable that each of a plurality of dishing prevention layers is formed of a plurality of dishing prevention layer portions and the electrode is formed immediately above each of a plurality of dishing prevention layer portions.

According to the present invention, a thin-film magnetic head comprising a read head portion which has a plurality of pairs of a lower shield and an upper shield functioning as a magnetic shield and a write head portion which is formed above this read head portion and has a plurality of pairs of a lower magnetic pole layer and an upper magnetic pole layer functioning as a magnetic pole is provided, wherein a dishing prevention portion is provided at the position farther than a plurality of lower shields from a position which becomes a medium opposed surface in both sides or either side along the track width direction of at least a plurality of lower shields among a plurality of lower shields, a plurality of upper shields, and a plurality of lower magnetic pole layers, and at least one electrode is provided immediately above the dishing prevention portion via an overcoat layer.

According to the thin-film magnetic head provided such dishing prevention portion, a height from the element formation surface of the head substrate of the dishing prevention portion can be adjusted depending on a height of the magnetic layer of the read head portion 21 and the write head portion 22. That is, the dishing prevention portion functions as an adjustment portion of the electrode position. This can make a whole upper surface of the overcoat layer parallel to the element formation surface of the head substrate. As a result, an upper surface (pad) of the electrode exposed on the upper surface of the overcoat layer can be also substantially parallel to the element formation surface. As the pad of the electrode is almost parallel to the element formation surface, when a probe contacts to the pad, a stable and higher reliability contact is possible. And, when the pad fixes to a lead, a stable and higher reliability fixing is also possible. Further, as the whole surface of the overcoat layer is almost parallel to the element formation surface, when a closure bonds to the overcoat layer, a stable and higher reliability bond is possible.

In the thin-film magnetic head according to the present invention, it is preferable that at least a plurality of lower shields and the dishing prevention portion are formed of a same magnetic material. Further, it is also preferable that at least a plurality of lower shields and the dishing prevention portion are formed of soft magnetic material such as FeSiAl (sendust) or NiFe (permalloy), amorphous soft magnetic material such as CoZrTa, or soft magnetic material which consists primarily of these material, and the overcoat layer is formed of Al₂O₃ (alumina).

Further, it is also preferable that the dishing prevention portion consists of a plurality of dishing prevention layers sequentially stacking via or not via the overcoat layer. In this case, it is also preferable that the dishing prevention portion is provided at the position farther than the lower shield, the upper shield, and the lower magnetic pole layer from the position which becomes the medium opposed surface in both sides or either side along the track width direction of each of a plurality of lower shields, a plurality of upper shields, and a plurality of lower magnetic pole layers, and that the upper surface of each of a plurality of lower shields, a plurality of upper shields, and a plurality of lower magnetic pole layers, and the upper surface of the dishing prevention portion are a flat surface whose heights are same. Furthermore, it is also preferable that each of a plurality of dishing prevention layers is formed of a plurality of dishing prevention layer portions and the electrode is formed immediately above each of a plurality of dishing prevention layer portions.

### BRIEF DESCRIPTION OF THE SEVERAL VIEWS OF THE DRAWINGS

FIG. 1a shows a perspective view schematically illustrating a configuration of an embodiment of the thin-film magnetic head according to the present invention;

FIG. 1b shows a cross-sectional view taken along plain A in FIG. 1a, illustrating a main part of the thin-film magnetic head according to the present invention;

FIG. 2 shows a cross-sectional view taken along plain B in FIG. 1a, illustrating a main part of an embodiment of the thin-film magnetic head according to the present invention;

FIGS. 3a to 3e show cross-sectional views schematically illustrating a part of a manufacturing method of a thin-film magnetic head not using a dishing prevention layer according to the present invention;

FIGS. 4a to 4d show cross-sectional views schematically illustrating a part of a manufacturing method of a thin-film magnetic head according to the present invention;

FIGS. 5a to 5d show schematic views illustrating a wafer substrate which a plurality of tape head pattern and a row bar formed by cutting off this wafer substrate, and a tape head (its leading portion or trailing portion);

FIGS. 6a and 6b show schematic views explaining samples in the comparative examples and the practical examples, and a measurement position of the polishing residual thickness in these samples;

FIG. 7 shows a graph of a measurement result of the polishing residual thickness in the comparative examples as shown in Table. 1; and

FIG. 8 shows a graph of a measurement result of the polishing residual thickness in the practical examples as shown in Table. 2.

### DETAILED DESCRIPTION OF THE INVENTION

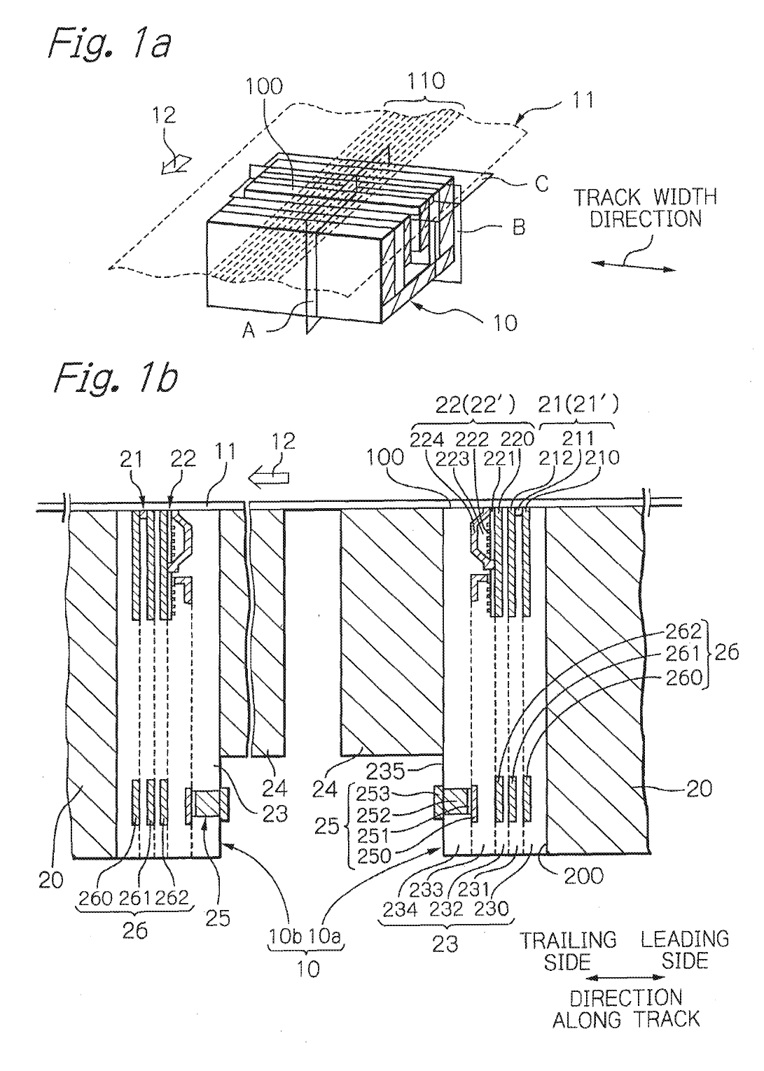

FIG. 1a shows a perspective view schematically illustrating a configuration of an embodiment of the thin-film magnetic head according to the present invention. Also FIG. 1b shows a cross-sectional view taken along plain A in FIG. 1a, illustrating a main part of the thin-film magnetic head according to the present invention.

According to FIG. 1a, reference numeral 10 denotes a tape head as a thin-film magnetic head for a magnetic tape, 11 denotes a magnetic tape as a magnetic recording medium with a plurality of tracks 110. The magnetic tape moves to direction of an arrow 12 in recording/reproducing. Further, the tape head 10 performs writing and reading operation of data signals toward the track 110 of the magnetic tape with contacting the moving tape 11 at a medium opposed surface (a sliding surface) 100 that is a head end surface of its own magnetic tape 11 side.

According to FIG. 1b, the tape head 10 is provided with a leading portion 10a and a trailing portion 10b. Here, as the leading portion 10a and the trailing portion 10b are opposed each other to a direction along the track and have a same constitution corresponding to each other, only leading portion 10a will be explained below. Further, the constitution that the tape head 10 has either the leading portion 10a or the trailing portion 10b is also scope of the present invention.

The leading portion 10a of the tape head 10 is provide with a head substrate 20 made of, for example, AlTiC (Al₂O₃-Tic), having an element formation surface 200 perpendicular to the medium opposed surface 100, a read head portion 21 to read data signals, formed on the element formation surface 200, a write head portion 22 to write data signals, formed immediately above the read head portion 21, an overcoat layer 23 formed on the element formation surface 200 so as to cover these read head portion 21 and write head portion 22, a closure 24 made of, for example, AlTiC (Al₂O₃-Tic), bonded to the overcoat layer 23 without a part of a upper surface 235 of the overcoat layer, provided on the overcoat layer 23, and a plurality of electrodes 25 formed on a exposing portion that is the upper surface 235 of the overcoat layer 23, not bonding to the closure 24. The electrode 25 is provided for the read head portion 21 and the write head portion 22, further as explained later, and for a resistance measurement of a RLG portion to adjust a MR height of the read head portion at the time of manufacturing.

Further, the leading portion 10a of the tape head 10 is provided with three dishing prevention portions 26 aligned to the stacking direction at immediately below each of a plurality of electrodes 25. Further, the electrodes 25 and the dishing prevention portions 26 do not intrinsically appear the cross-sectional surface taken along plain A, but for convenience of explanation, these appear the cross-sectional surface.

Each of the read head portion 21 and the write head portion 22 are electrically connected to a part of a plurality of electrodes 25. Further, in the read head portion 21 and the write head portion 22, these one ends reach the medium opposed surface 100 and contact the magnetic tape 11. But if an ultra thin protective layer made of diamond-like carbon (DLC) and so on is formed on the medium opposed surface 100 in such a way as to cover the one end of the read head portion 21 and the write head portion 22, this one end opposes the magnetic tape 11 via this protective layer. In this arrangement, at the time of writing and reading operation, the write head portion 22 performs writing to the moving magnetic tape 10 by applying signal magnetic fields and the read head portion 21 performs reading from the moving magnetic tape 10 by sensing signal magnetic fields.

The read head portion 21 has constitution that a plurality of MR effect elements 21′ are arranged along the track width direction. Here, each MR effect element 21′ reads out data signals from each of a plurality of tracks 110, and corresponds to the multi channel. Further, in FIG. 1b, the only one MR effect element 21′ is shown. As shown in FIG. 1b, each of a plurality of MR effect elements 21′ includes an MR effect multilayer 211, and a lower shield 210 and an upper shield 212 arranged at a position sandwiching this multilayer with a pair. Therefore, the read head portion 21 is provided with pairs of a plurality of upper and lower shields 212 and 210 arranged along the track width direction. Their upper and lower shields 212 and 210 prevent the MR effect multilayer 211 from receiving an external magnetic field that causes noise. The upper and lower shields 212 and 210 are a magnetic layer and are formed of multilayer film that is, for example, soft magnetic material such as FeSiAl (sendust), NiFe (permalloy), CoFeNi, CoFe, FeN, or FeZrN, amorphous soft magnetic material such as CoZrTa, or CoZrTaCr, or these material, with a thickness of approximately 0. 5-3 μm (micro meter) using such as frame plating or sputtering.

The MR effect multilayer 211 is a magneto-sensitive portion using the MR effect, for example, can include an AMR effect multilayered film using an anisotropic magnetoresistive (AMR) effect, a GMR effect multilayered film using a giant magnetoresistive (GMR) effect, or a TMR effect multilayered film using a tunnel magnetoresistive (TMR) effect. Further, if the MR effect multilayer 332 includes the GMR effect multilayered film, it can include a current-in-plane (CIP) GMR effect multilayered film or a current-perpendicular-to-plane (CPP) GMR effect multilayered film. Any MR effect multilayer 211 using these MR effects senses signal magnetic fields from the magnetic tape 10 with high sensitivity. If the MR effect multilayer 211 is the CPP-GMR effect multilayered film or the TMR effect multilayered film, the upper and lower shields 212 and 210 function as the electrode. Whereas, if the MR effect multilayer 211 is the CIP-GMR effect multilayered film or the AMR effect multilayered film, an insulating layer is provided between the MR effect multilayer 211, and the upper and lower shields 212 and 210, further, an MR lead layer electrically connected to the MR effect multilayer 211 is provided.

The write head portion 22 has constitution that a plurality of an electromagnetic conversion elements 22′ arrange along the track width direction on a plurality of MR effect elements 21′. Further, in FIG. 1b, only one electromagnetic conversion element 22′ is shown. As shown in FIG. 1b, each of a plurality of electromagnetic conversion elements 22′ is provided with a lower magnetic pole layer 220, an upper magnetic pole layer 224, a write gap layer 221 which an end portion of the medium opposed surface 100 side is sandwiched by the lower magnetic pole layer 220 and the upper magnetic pole layer 224, an write coil layer 222 formed in such a manner that it passes at least between the upper and lower magnetic pole layers 224 and 220 between one turn, and a coil-insulating layer 223 to insulate the write coil layer 222 from the upper and lower magnetic pole layers 224 and 220. Therefore, the write head portion 22 is provided with pairs of a plurality of upper and lower magnetic pole layers 224 and 220 arranged along the track width direction.

The lower magnetic pole layer 220 and the upper magnetic pole layer 224 are a magnetic path to guide and converge the magnetic flux excited by currents flowing through the write coil layer 222 and sandwich the end portion of the medium opposed surface 100 side of the write gap layer 221 by their end portion. A leakage magnetic field from this sandwiched end portion of the write gap layer 221 performs a write operation onto the magnetic disk. While the write coil layer 222 is shown as a single layer in FIG. 1b, it may consist of two or more layers structure or a helical coil structure. Also, One magnetic layer can be used as both the upper shield 212 and the lower magnetic pole layer 220.

The lower magnetic pole layer 220 is a magnetic layer and is formed of multilayer film that is, for example, soft magnetic material such as FeSiAl (sendust), NiFe (permalloy), CoFeNi, CoFe, FeN, or FeZrN, amorphous soft magnetic material such as CoZrTa, or CoZrTaCr, or these material, with a thickness of approximately 0.5-3 μm using such as frame plating or sputtering. The write gap layer 221 is a nonmagnetic layer, and is formed of insulating material, for example, such as Al₂O₃ (alumina), SiO₂ (silicon dioxide), AlN (aluminum nitride), or DLC, with a thickness of approximately 0.01-0.05 μm by using such as sputtering or chemical vapor deposition (CVD). The write coil layer 222 is a conductive layer and is formed of, for example, Cu, etc. with a thickness of approximately 0.5-5 μm by using such as frame plating or sputtering. The coil-insulating layer 223 is a plastic insulating layer and is formed of, for example, a heat-cured novolac-type, etc. photo resist with a thickness of approximately 0.7-7 μm by using such as photolithography. The upper magnetic pole layer 224 is a magnetic layer and is formed of multilayer film that is, for example, soft magnetic material such as FeSiAl (sendust), NiFe (permalloy), CoFeNi, CoFe, FeN, or FeZrN, amorphous soft magnetic material such as CoZrTa, or CoZrTaCr, or these material, with a thickness of approximately 0.5-3 μm using such as frame plating or sputtering.

The overcoat layer 23 consists of a first overcoat layer 230, a second overcoat layer 231, a third overcoat layer 232, a fourth overcoat layer 233, and a fifth overcoat layer 234. These layers are formed with stacking nonmagnetic insulating material, for example, such as Al₂O₃ (alumina), SiO₂ (silicon dioxide), AlN (aluminum nitride), or DLC, by using such as sputtering or CVD.

The dishing prevention portion 26 consists of, in this embodiment, a first dishing prevention layer 260 formed in the first overcoat layer 230, a second dishing prevention layer 261 formed in the second overcoat layer 231, and a third dishing prevention layer 262 formed in the third overcoat layer 232. While not shown in FIG. 1b, each of the first to third dishing prevention layers 260 to 262 are formed of a plurality of layer portions arranged along the track width direction as explained later.

Further, an upper surface of the first dishing prevention layer 260 is planarized in the form that this height from the element formation surface 200 is a same as the height of an upper surface of the lower shield 210 and an upper surface of the first overcoat layer 230. Also, an upper surface of the second dishing prevention layer 261 is planarized in the form that this height from the element formation surface 200 is a same as the height of an upper surface of the upper shield 212 and an upper surface of the second overcoat layer 231. Further, an upper surface of the third dishing prevention layer 262 is planarized in the form that this height from the element formation surface 200 is a same as the height of an upper surface of the lower magnetic pole layer 220 and an upper surface of the third overcoat layer 232.

Here, the first to third dishing prevention layers 260 to 262 are formed of a same manufacturing method and same material as the lower shield 210, the upper shield 212, and the lower magnetic pole layer 220, respectively, and these layers thickness are same as, respectively. That is to say, the first to third dishing prevention layers 260 to 262 are formed of CoZrTa, if the lower shield 210, the upper shield 212, and the lower magnetic pole layer 220 are formed of, for example, CoZrTa. But, in other embodiment, the first to third dishing prevention layers 260 to 262 can be formed of different material, which has same polishing rate due to the CMP, from the lower shield 210, the upper shield 212, and the lower magnetic pole layer 220, respectively.

The electrode 25 is provided with a lead electrode 250, a base electrode film 251, a bump 252 and a pad 253. Here, the lead electrode 250 is electrically connected to a lead pulled out from the MR effect element 21′, the electromagnetic conversion element 22′, or the RLG portion. The base electrode film 251 having conductive property is formed on this lead electrode 250, further, the bump 252 is formed of this base electrode film 251 as the electrode by plating. The base electrode film 251 and the bump 252 consist of conductive material such as Cu. The thickness of the base electrode film 251 is approximately 10-200 nm (nanometer), and the thickness of the bump 252 is approximately 5-30 μm. Here, an upper end of the bump 252 exposes from the upper surface 235 of the overcoat layer 23, and the pad 253 is provided on this upper end.

The dishing prevention portion 26, that is the first to third dishing prevention layers 260 to 262, positions just below this electrode 25. Here, in the first to third dishing prevention layers 260 to 262, as above-mentioned, the height from the element formation surface 200 is adjusted to the height of the magnetic layer of the read head portion 21 and the write head portion 22. This makes the whole upper surface 235 of the overcoat layer 23 almost parallel to the element formation surface 200. As a result, the pad 253 of the electrode 25 exposed on the upper surface 235 of the overcoat layer 23 is also adjusted almost parallel to the element formation surface 200. That is, the dishing prevention portion 26 functions as an adjustment portion of an electrode position.

As the pad 253 is almost parallel to the element formation surface 200, a stable and higher reliability contact is possible when the pad 253 contacts to a probe. Also, when the pad 253 fixes to the lead, a stable and higher reliability fixing is also possible. Further, as the whole upper surface 235 of the overcoat layer 23 is almost parallel to the element formation surface 200, when the closure 24 bonds to the overcoat layer 23, a stable and higher reliability bond is possible.

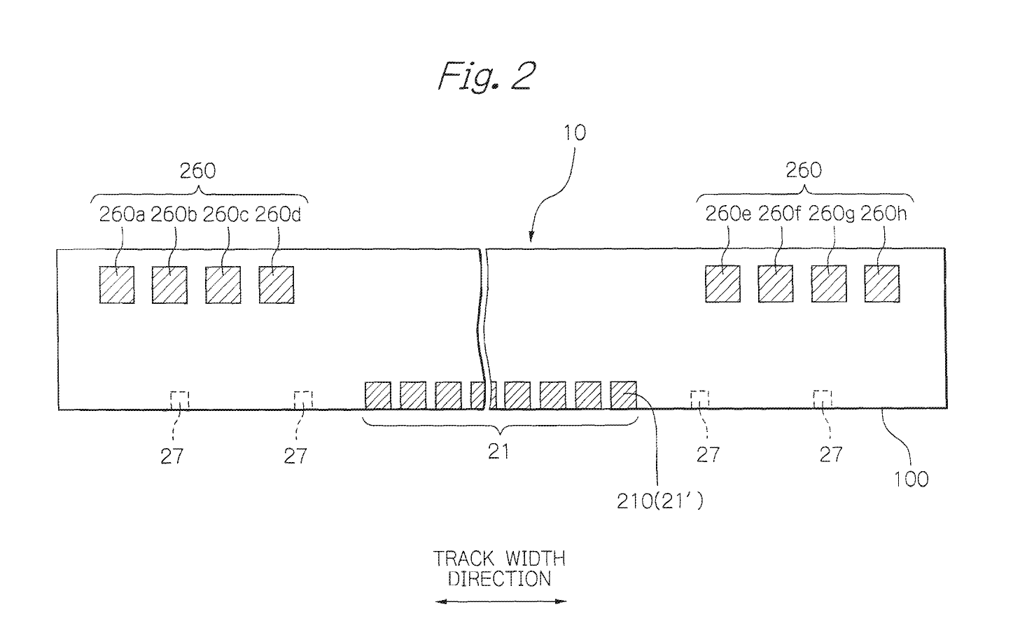

FIG. 2 shows a cross-sectional view taken along plain B in FIG. 1a, illustrating a main part of an embodiment of the thin-film magnetic head according to the present invention. In a cross-section in FIG. 2, the upper surface of the first dishing prevention layer 260, the upper surface of the lower shield 210, and the upper surface of the first overcoat layer 230 in FIG. 1a appear.

According to FIG. 2, one chip of the tape head 10 has a long and thin rectangle shape along the track width direction. In this tape head 10, the read head portion 21 is in a middle portion along the track width direction, and is formed so as to reach the medium opposed surface 100, and consists of a plurality of MR effect elements 21′ (in FIG. 2, only the lower shield 210 appears) arranged along the track width direction. Here, the number of the MR effect elements 21′ can be set according to the number of the tracks 110 on the magnetic tape 11. For example, the number of the MR effect elements 21′ can be one in the case of the single track, and the number can be eight in the case of the eight tracks. Further, if the data tracks are 16 and servo tracks are provided on both sides, respectively, the 18 MR effect elements 21′ containing two MR effect elements for the servo tracks can be provided. Also, a plurality of RLG portions 27 are in both sides along the track width direction of the read head portion 21 and are formed so as to reach the medium opposed surface 100. The RLG portion 27 is a resistance pattern, and is used to control the amount of polishing and to adjust the MR height of the read head portion 21 in the MR height process operation at the time of manufacturing head. Specifically, by monitoring a resistance value of the RLG portion 27 cutting by polishing, it is possible to obtain the appropriate amount of polishing. Further, the RLG portion intrinsically appears in a same stacked surface as, for example, the MR effect multilayer 211, but in FIG. 2, for convenience of explanation, it is denoted by dashed line.

The first dishing prevention layer 260 consists of a plurality of dishing prevention layer portions 260a to 260d and a plurality of dishing prevention layer portions 260e to 260h arranged along the track width direction. These dishing prevention layer portions 260a to 260d and 260e to 260h are formed at the position farther than a plurality of lower shields 210 from the medium opposed surface 100 in both sides along the track width direction of a plurality of lower shields 210 in the read head portion 21. Here, the volume of the dishing prevention layer portions 260a to 260h is, for example, approximately 480×160 μm, and are lined by four with, for example, approximately 600-1000 μm pitch.

Although the lower shield 210 and the first dishing prevention layer 260 are shown in FIG. 2, the upper shield 212 and the second dishing prevention layer 261 shown in FIG. 1, and the lower magnetic pole layer 220 and the third dishing prevention layer 261 shown in FIG. 1 are also arranged with a same constitution as the lower shield 210 and the first dishing prevention layer 260. As a result, each of a plurality of electromagnetic conversion elements 22′ in the write head portion 22 is formed on each of a plurality of MR effect elements 21′. Also, the second dishing prevention layer 261 and the third dishing prevention layer 262 are sequentially stacked on the first dishing prevention layer 260 via the overcoat layer. Further, the electrode 25 is formed immediately above the first to third dishing prevention layer 260 to 262.

Although the constitution of the first to third dishing prevention layers 260 to 262 have explained, it is not always necessary that the dishing prevention layer is three layers, for example, the constitution which has only the first and second dishing prevention layers 260 and 261 or only the first dishing prevention layer 260 can be possible. In these constitutions, a position (height) of the electrode can be adjustable. The constitution that the RLG portion 27 and the electrode for the RLG portion are not provided is also scope of the present invention if the dishing prevention layer to adjust the position of the electrode for the read head portion 21 and the write head portion 22 is provided.

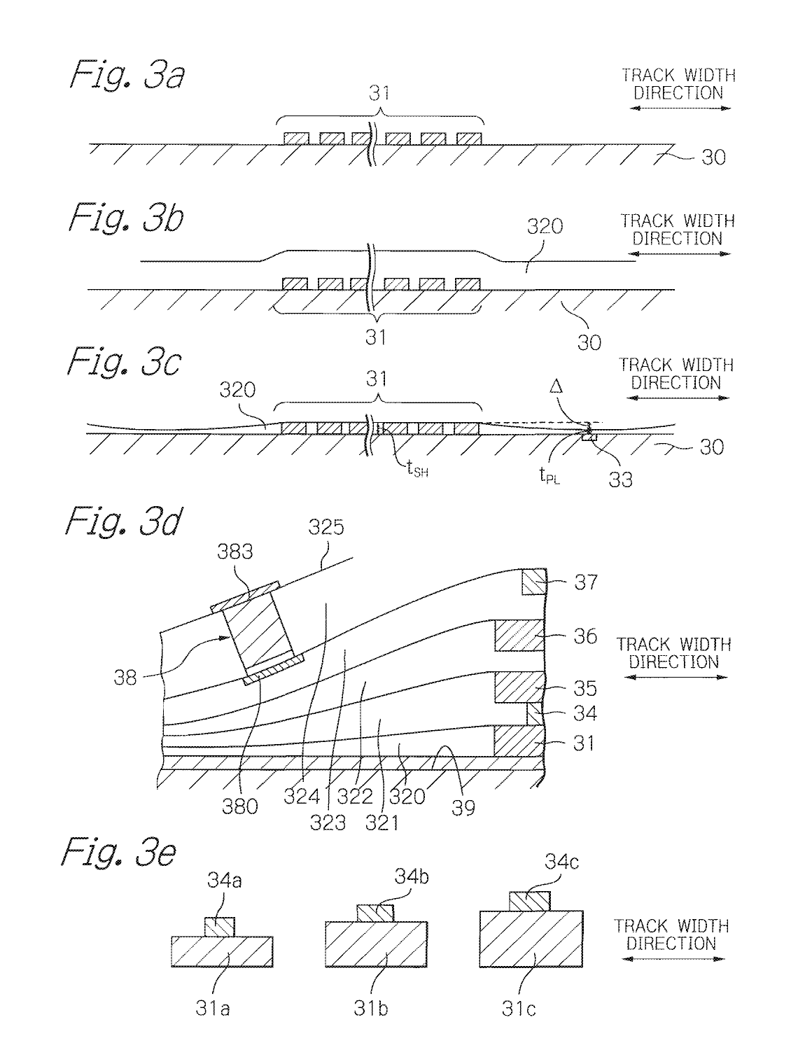

FIGS. 3a to 3e show cross-sectional views schematically illustrating a part of a manufacturing method of a thin-film magnetic head not using a dishing prevention layer according to present invention. These cross-section surfaces correspond to a cross-section surface taken along plain C in FIG. 1a. Here, in FIG. 3d, although the electrode does not intrinsically appear in this cross-section surface, but for convenience of explanation, this appears the cross-sectional surface. Later, with these figures, the manufacturing method of the thin-film magnetic head not using the dishing prevention layer according to the present invention will be explained about mainly the process to form the lower shield. Further, these figures correspond to any one in a plurality of tape head patterns formed on the element formation surface of the wafer substrate.

First, as shown in FIG. 3a, a plurality of magnetic layers 31 which become a plurality of lower shields arranged along the track width direction are formed on a base coat layer 30 which consists of nonmagnetic insulating material such as Al₂O₃ (alumina) or SiO₂ (silicon dioxide) and is formed on the element formation surface (not shown) of the wafer substrate. A plurality of magnetic layers 31 are formed with stacking, for example, such as CoZrTa by using such as sputtering. Next, as shown in FIG. 3b, a planarizing layer 320 which becomes the first overcoat layer is formed so as to cover a plurality of magnetic layers 31. The planarizing layer 320 is formed with stacking Al₂O₃ (alumina) by using such as sputtering or CVD.

Next, as shown in FIG. 3c, an upper surface of the formed planarizing layer 320 is planarized using the chemical mechanical polishing (CMP) on whole wafer substrate until a plurality of magnetic layers 31 expose completely. On this occasion, any pattern is not formed at vicinity of the both end portions along the track width direction in one tape head pattern, therefore the dishing occurs because the planarizing layer 320 is mainly polished. Here, the dishing is a phenomenon to be formed a dished area in the wafer substrate. In this embodiment, the dishing occurs by reason that the polishing rate due to the CMP is widely different, for example, between CoZrTa forming a plurality of magnetic layers 31 and Al₂O₃ (alumina) forming the planarizing layer 320. Indeed, as Al₂O₃ (alumina) has a larger polishing rate than CoZrTa, the polishing rate becomes larger at vicinity of the both end portions along the track width direction.

Here, in a plurality of magnetic layers 31 after planarization, the layer thickness at vicinity of the middle position along the track width direction is defined to be t_{SH}. Also, the maker 33 for monitoring the layer thickness at vicinity of the both end portions along the track width direction where the dishing occurs is set, and the layer thickness of the planarizing layer 320 at the maker 33 after planarization is defined to be t_{PL}. By measuring the difference Δ=t_{SH}−t_{PL}, the degree of the dishing can be expressed.

Next, as shown in FIG. 3d, on a plurality of formed magnetic layers 31, the MR effect multilayer 34 is formed by using a usually forming method. Next, on the MR effect multilayer 34, a plurality of magnetic layers 35 which become a plurality of upper shields arranged along the track width direction and the planarizing layer 321 which becomes the second overcoat layer are formed by using the method shown in FIGS. 3a to 3c. Further, on these layers, a plurality of magnetic layers 36 which become a plurality of lower magnetic pole layers arranged along the track width direction and the planarizing layer 322 which becomes the third overcoat layer are formed by using the method shown in FIGS. 3a to 3c. Further, by using the usually forming method, a plurality of magnetic layers 37 which become a plurality of upper magnetic pole layers and the planarizing layer 323 which becomes the fourth overcoat layer are formed, and then the write head portion is formed. Further, after the planarizing layer 325 which becomes the fifth overcoat layer is formed, the electrode 38 is formed by using the usually forming method. Further, a lead electrode 380 is formed when a plurality of magnetic layers 37 and the planarizing layer 323 are formed.

By above explained forming method, the read head portion, the write head portion, and the electrode 38 are formed. Here, as shown in FIG. 3d, an upper surface 325 of the planarizing layer 324 is not parallel to the element formation surface 39 of the wafer substrate and tilt at vicinity of the both end portions along the track width direction because dishing portions occurred on the planarizing layer 320 to 323 overlap. Therefore, the pad 383 of the electrode 38 also tilts toward the element formation surface 39. As a result, the problem that when the pad 383 contacts the probe, the contact is not stable and when the pad 383 fixes to the lead, the fixing is not stable occurs. Further, the problem that when the closure 24 bonds to the upper surface 325, the bond is not stable occurs.

Further, in a plurality of magnetic layers 31, a distribution of the layer thickness occurs by the dishing. That is to say, as shown in FIG. 3e, the phenomenon that the outer, the layer thickness of the magnetic layer is smaller occurs as a magnetic layers 31a, 31b, and 31c, with covering a hem of the dishing at both end portions along the track width direction. If these distribution exists in the layer thickness of a plurality of magnetic layers 31, in the case of forming a plurality of MR effect multilayers 34 in subsequent process, a focus exposure toward a resist layer used in a patterning of the MR effect multilayers 34a, 34b, and 34c is be distributed. As a result, it is difficult to realize the most suitable exposure at all position on a plurality of magnetic layers 31. The problem that this reduces a yield ratio occurs.

Furthermore, generally, it is found that the degree of the dishing changes each time. Therefore, it is found that controlling the distribution of the layer thickness is difficult even if the dishing by the measurement value of Δ=t_{SH}−t_{PL}, at above mentioned maker position is managed and the layer thickness at a plurality of magnetic layers 31 is adjusted.

As explained above, it is found that a bad effect due to the dishing occurs in the case of not using a dishing prevention layer according to the present invention, next a manufacturing method using a dishing prevention layer according to the present invention will be explained.

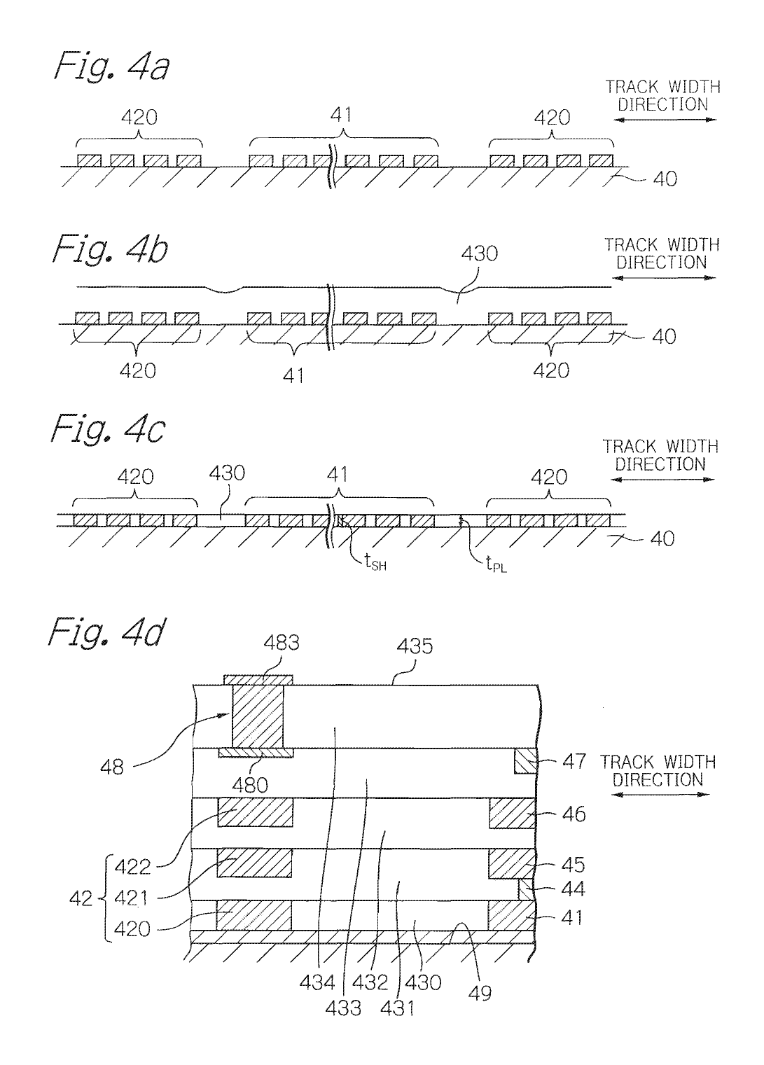

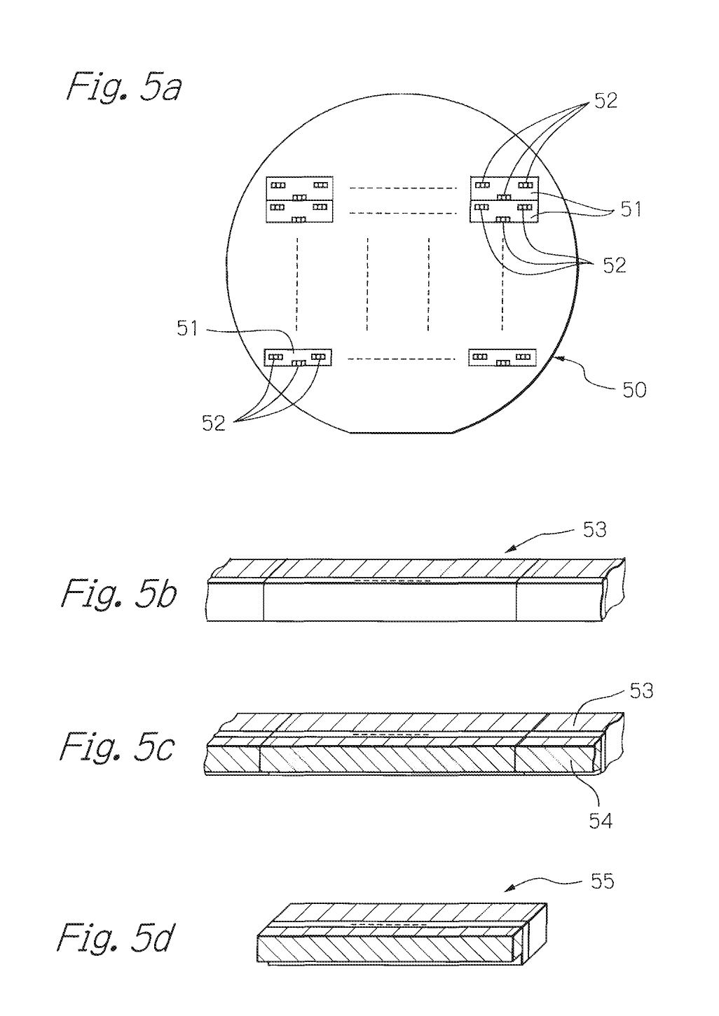

FIGS. 4a to 4d show cross-sectional views schematically illustrating a part of an embodiment of a manufacturing method of a thin-film magnetic head according to the present invention. These cross-section surfaces also correspond to a cross-section surface taken along plain C in FIG. 1a. Here, in these figures, although the dishing prevention layer and the electrode do not intrinsically appear in this cross-section surface, but for convenience of explanation, these appear the cross-sectional surface. Further, these figures correspond to any one in a plurality of tape head patterns formed on the element formation surface of the wafer substrate. Also, FIGS. 5a to 5d show schematic views illustrating a wafer substrate which a plurality of tape head patterns and a row bar formed by cutting off this wafer substrate, and a tape head (its leading portion or trailing portion). Later, with these figures, the manufacturing method of the thin-film magnetic head using the dishing prevention layer according to the present invention will be explained about mainly the process to form the lower shield 210.

First, as shown in FIG. 4a, a plurality of magnetic layers 41 which become a plurality of lower shields 210 arranged along the track width direction and a plurality of dishing prevention layers 420 which become the first dishing prevention layer 260 arranged along the track width direction are formed on a base coat layer 40 which consists of nonmagnetic insulating material such as Al₂O₃ (alumina) or SiO₂ (silicon dioxide) and formed on the element formation surface (not shown) of the wafer substrate. The both of a plurality of magnetic layers 41 and a plurality of dishing prevention layers 420 are formed with stacking, for example, such as CoZrTa by using such as sputtering at the same time, that is, these are formed to a same layer thickness. Next, as shown in FIG. 4b, a planarizing layer 430 which becomes the first overcoat layer 230 is formed so as to cover a plurality of magnetic layers 41 and a plurality of dishing prevention layers 420. The planarizing layer 430 is formed with stacking Al₂O₃ (alumina) by using such as sputtering or CVD.

Next, as shown in FIG. 4c, an upper surface of the formed planarizing layer 430 is planarized using the CMP on whole wafer substrate until a plurality of magnetic layers 41 and a plurality of dishing prevention layers 420 expose completely. On this occasion, in one tape head pattern, a plurality of dishing prevention layers 420 are formed at vicinity of the both end portions along the track width direction, as a plurality of dishing prevention layers 420 which are a same material and have a same layer thickness as the magnetic layers 41 are mainly polished at this position, the occurrence of the dishing is suppressed.

That is to say, in FIG. 5a, as a portion 52 which consists of, for example, CoZrTa whose polishing rate is lower than that of Al₂O₃ (alumina) is distributed uniformly at predetermined ratio in whole element formation surface of the wafer substrate 50 formed a plurality of tape head patterns 51, the dishing rate due to the CMP becomes almost uniform.

Further, it should be pay attention that a plurality of dishing prevention layers 420 do not make a pattern density in one tape head pattern uniform. If a dummy pattern is formed to make the pattern density in one tape head pattern uniform, as a result, many ferromagnetic material patterns are formed at a portion except for the shield. These ferromagnetic material patterns frequently reduce head resistance property against external magnetic field, especially, the ferromagnetic material patterns at vicinity of a head end surface of the magnetic tape side bring the magnetic tape unnecessary magnetic field. Therefore, it is not preferable to form this dummy pattern.

Here, back to FIG. 4c, in a plurality of magnetic layers 41 after planarization, the layer thickness at vicinity of the middle position along the track width direction is defined to be t_{SH}. Also, the layer thickness of the planarizing layer 430 at the middle position between a plurality of magnetic layers 41 and a plurality of dishing prevention layers 420 is defined to be t_{PL}, then in the present invention, it is possible to be almost t_{SH}=t_{PL}. Further, in above embodiment, a plurality of dishing prevention layers 420 are provided on both sides along the track width direction of a plurality of magnetic layers 41, but it possible that these are provided on only one side in the both sides. In other words, in FIG. 5a, if the portion 52 whose polishing rate is lower is distributed uniformly at predetermined ratio in whole element formation surface of the wafer substrate 50, it is possible to prevent the dishing.

Next, as shown in FIG. 4d, on a plurality of formed magnetic layers 41, the MR effect multilayer 44 is formed by using a usually forming method. Next, on the MR effect multilayer 44, a plurality of magnetic layers 45 which become a plurality of upper shields 212 arranged along the track width direction, a plurality of dishing prevention layers 421 which become the second dishing prevention layer 261, and a planarizing layer 431 which becomes the second overcoat layer 231 are formed by using the method shown in FIGS. 4a to 4c. Further, on these layers, a plurality of magnetic layers 46 which become a plurality of lower magnetic pole layers 220 arranged along the track width direction, a plurality of dishing prevention layers 422 which become the third dishing prevention layer 262, and a planarizing layer 432 which becomes the third overcoat layer 232 are formed by using the method shown in Figs.

Further, in a plurality of magnetic layers 41, as the layer thickness distribution as shown in FIG. 3e hardly ever occurs, in the case of forming a plurality of MR effect multilayers 44 in subsequent process, it is easy to set a focus exposure toward a resist layer used in a patterning. As a result, it is possible to realize the most suitable exposure at all position on a plurality of magnetic layers 41. This can reduce a yield ratio.

Afterward, by cutting and separation the wafer substrate 50 finished a thin-film process operation, as shown in FIG. 5b, the row bar 53 where a plurality of tape head patterns are arranged at least one row is cut out. Next, as shown in FIG. 5c, a closure block 54 which becomes the closure is bonded to the upper surface of the overcoat layer of the row bar 53. Next, an MR height process is performed to adjust the MR height that is a depth (length) in a direction to perpendicular the medium opposed surface of the MR effect multilayer. On this occasion, by polishing with monitoring a resistance value of the RLG portion via the electrode for the RLG portion and finishing the polishing at the time of becoming the predetermined resistance value, the desirable MR height is obtained. Finally, as shown in FIG. 5d, by cutting and separation the row bar 53 which the closure block 54 bonds to, and by cutting out the tape head (its trailing portion and leading portion), the manufacturing process has finished.

Hereinafter, an effect to improve the distribution of the polishing residual thickness by the dishing suppressing with the dishing prevention portion according to the present invention will be explained by comparative examples and practical examples.

(An explanation of samples in the comparative examples and the practical examples)

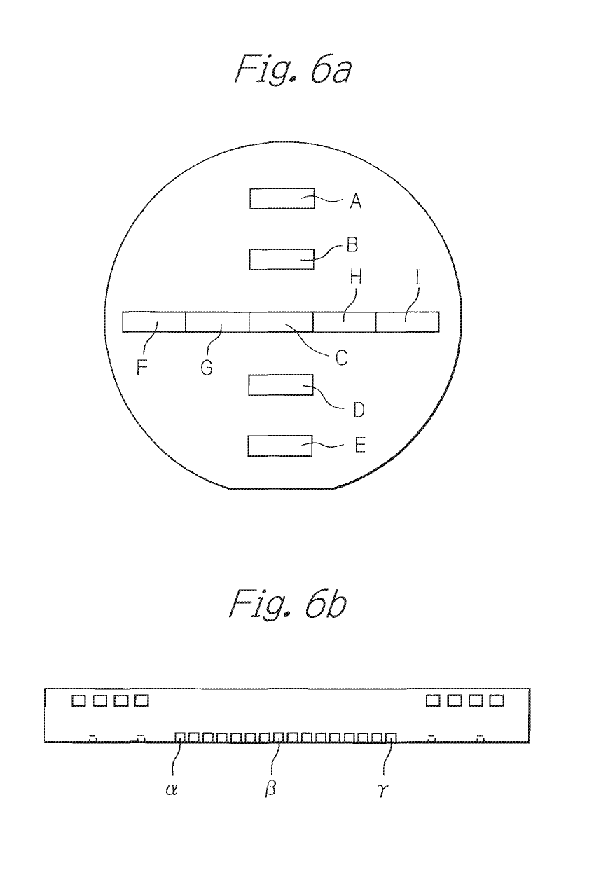

FIGS. 6a and 6b show schematic views explaining samples in the comparative examples and the practical examples, and a measurement position of the polishing residual thickness in these samples.

As shown in FIG. 6a, the samples in the comparative examples and the practical examples were the six inch diameter wafer substrate which was formed a large tape head patterns whose size was 1 mm×30 mm as a matrix state and consisted of AlTiC (Al₂O₃-Tic). Here, in the samples in the comparative examples, as shown in FIG. 3a to 3c, the magnetic layers 31 which became the 16 lower shields and consisted of CoZrTa were polished by the CMP with the planarizing layer 320 which consisted of Al₂O₃ (alumina). Whereas, in the samples in the practical examples, as shown in FIG. 4a to 4c, the magnetic layers 41 which became the 16 lower shields and consisted of CoZrTa and the dishing prevention layers 420 which became the first dishing prevention layer 260 lined by four at both sides along the track width direction and consisted of CoZrTa were polished by the CMP with the planarizing layer 430 which consisted of Al₂O₃ (alumina).

Also, in the samples in the comparative examples and the practical examples, the tape head patterns measuring the polishing residual thickness at the position of the magnetic layers 31 or 41 were, as shown in FIG. 6a, total nine of from A to I. Here, the head patterns A, E, F, and I were positioned at a circumference of the wafer substrate, the head pattern C was positioned at a center of the wafer substrate, and the head patterns B, D, G, and H were positioned at a middle position between the circumference and the center. Further, as shown in FIG. 6b, the measurement of the polishing residual thickness in each tape head pattern was performed at a first magnetic layer a and a 16th magnetic layer γ positioned both sides, respectively, and a eighth magnetic layer β positioned almost the center, in the 16 magnetic layers 31 or 41 arranged along the track width direction. Here, in any samples, the measurement of the polishing residual thickness was performed by using an optical interferometry type film thickness measuring apparatus. On this occasion, the polishing residual thickness, that is residual thickness after the polishing, was defined to be a distance between the polishing surface of the magnetic layer and the element formation surface of the wafer substrate.

(A measurement result of the polishing residual thickness in samples in the comparative examples and the practical examples)

Table 1 shows a measurement result of the polishing residual thickness in the comparative examples.

TABLE 1

| | | | | Difference |
|---|---|---|---|---|
| | | | | between |
| | | | | maximum and |
| Head pattern | a | β | γ | minimum II |
| A | 29217 | 29927 | 29088 | 839 |
| B | 25427 | 26474 | 25360 | 1114 |
| C | 22868 | 24247 | 23056 | 1379 |
| D | 24340 | 25721 | 24538 | 1381 |
| E | 26658 | 27671 | 26668 | 1013 |
| F | 26401 | 26891 | 26173 | 718 |
| G | 23768 | 25080 | 23640 | 1440 |
| H | 26498 | 27782 | 26586 | 1284 |
| I | 25979 | 26331 | 25766 | 565 |
| Mean value | 25684.0 | 26680.4 | 25652.8 | |
| Standard | 1876.4 | 1671.4 | 1806.5 | |
| deviation | | | | |
| Difference | 6349 | 5680 | 6032 | |
| between | | | | |
| maximum and | | | | |
| minimum I | | | | |

unit: nm (nanometer)

Table 2 shows a measurement result of the polishing residual thickness in the comparative examples.

TABLE 2

| | | | | Difference |
|---|---|---|---|---|
| | | | | between |
| | | | | maximum and |
| head pattern | a | β | γ | minimum II |
| A | 22815 | 23177 | 22789 | 388 |
| B | 21966 | 22295 | 21889 | 406 |
| C | 21974 | 22442 | 22010 | 468 |
| D | 21980 | 22409 | 22041 | 429 |
| E | 22482 | 23023 | 22496 | 541 |
| F | 20658 | 20416 | 19852 | 806 |
| G | 22392 | 22842 | 22220 | 622 |
| H | 23869 | 24225 | 23861 | 364 |
| I | 21908 | 22130 | 22292 | 384 |
| Mean value | 22227.1 | 22551.0 | 22161.1 | |
| Standard | 858.1 | 1020.7 | 1052.4 | |
| deviation | | | | |
| Difference | 3211 | 3809 | 4009 | |
| between | | | | |
| maximum and | | | | |
| minimum I | | | | |

unit: nm (nanometer)

As shown in Tables 1 and 2, dispersions (standard deviation) of the polishing residual thickness among the head patterns A-I are 1876.4 (a position), 1671.4 (B position), and 1806.5 (γ position) in Table 1 (the comparative examples), in contrast, are 858.1 (a position), 1020.7 (β position), and 1052.4 (γ position) in Table 2 (the practical examples). That is to say, in the practical examples, it is understood that the dispersions of the residual thickness in the head patterns A-I are widely suppressed. With this, the difference between maximum and minimum I, that is a difference between a maximum value and a minimum value of the residual thickness among the head patterns A-I, is also smaller in the practical examples. Further, it is understood that the dispersions of the residual thickness among the positions (a, β, γ) in one head pattern (the difference between maximum and minimum II) is also suppressed in the practical examples. With this, a dispersion of the mean value of the residual thickness among the position (a, β, γ) in one head pattern is also smaller in the practical examples.

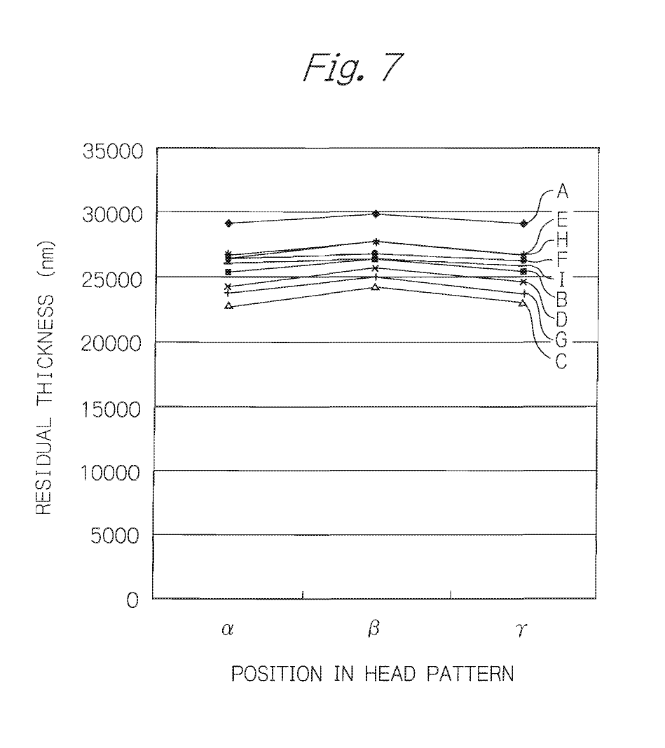

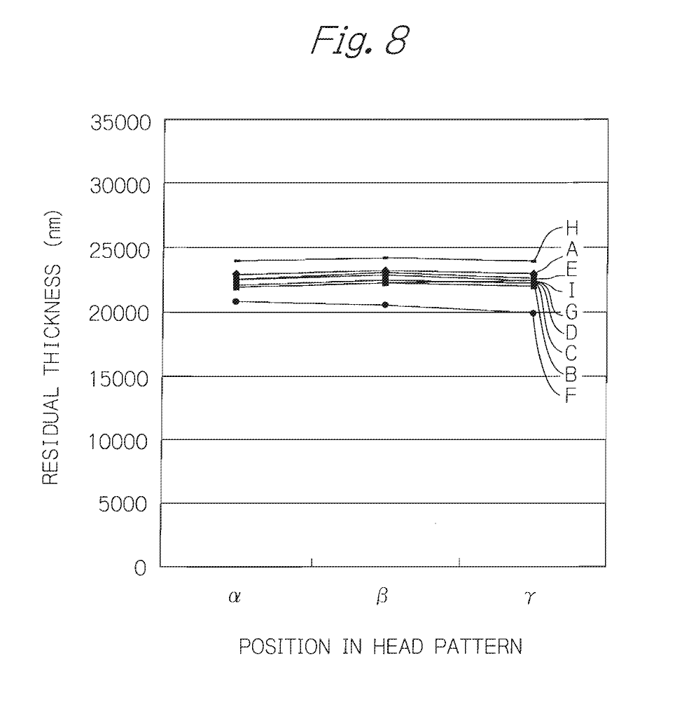

FIG. 7 shows a graph of a measurement result of the polishing residual thickness in the comparative examples as shown in Table. 1, and FIG. 8 shows a graph of a measurement result of the polishing residual thickness in the practical examples as shown in Table. 2.

Comparing with FIG. 7 (the comparative examples) and FIG. 8 (the practical examples), in the practical examples, it is found that the dispersions of the polishing residual thickness among the head patterns A-I are smaller than those in the comparative examples and are suppressed. Also, in the comparative examples, the β position tends to show the largest residual thickness in the positions (a, β, γ) in one head pattern, whereas, in the practical examples, it is found that the residual thickness in the positions (a, β, γ) in one head pattern is almost constant.

Above mentioned, it is understood that by providing the dishing prevention portion according to the present invention, 4a to 4c. Further, by using a usually forming method, a plurality of magnetic layers 47 which become a plurality of upper magnetic pole layers 224 and a planarizing layer 433 which becomes the fourth overcoat layer 233 are formed, and then the write head portion is formed. Further, after a planarizing layer 434 which becomes the fifth overcoat layer 234 is formed, an electrode 48 is formed by using a usually forming method. Further, a lead electrode 480 is formed when a plurality of magnetic layers 47 and the planarizing layer 433 are formed.

By above explained method, the read head portion, the write head portion, and the electrode 48 are formed. Here, as shown in FIG. 4d, an upper surface 435 of the planarizing layer 434 can be almost parallel to the element formation surface 49 of the wafer substrate as a result that the dishing prevention portion 42 which consists of a plurality of dishing prevention layers 420, 421, and 422 is used. Therefore, the pad 483 of the electrode 48 can be also almost parallel to the element formation surface 49. As a result, when the pad 483 contacts to a probe, a stable and higher reliability contact is possible. And, when the pad 483 fixes to a lead, a stable and higher reliability fixing is also possible. Further, as the whole surface 435 of the planarizing layer 434 is almost parallel to the element formation surface 49, when a closure bonds to the overcoat layer, a stable and higher reliability bond is possible. the dishing is prevented, then the dispersion of the polishing residual thickness among the head patterns in the wafer substrate is suppressed, further, the dispersion of the polishing residual thickness among the positions in one head pattern is also suppressed.

All the foregoing embodiments are by way of example of the present invention only and not intended to be limiting, and many widely different alternations and modifications of the present invention may be constructed without departing from the spirit and scope of the present invention. Accordingly, the present invention is limited only as defined in the following claims and equivalents thereto.

1. A manufacturing method of a thin-film magnetic head comprising a read head portion for data reading which has at least two magnetic layers functioning as a magnetic shield and a write head portion for data writing which has two magnetic layers functioning as a magnetic pole,
in a process forming at least the lowest magnetic layer in at least the two magnetic layers functioning as the magnetic shield and the two magnetic layers functioning as the magnetic pole in the case of forming a plurality of thin-film magnetic head patterns on an element formation surface of a wafer substrate comprising steps of:
forming said magnetic layer so as to reach a position which becomes a medium opposed surface at a middle portion along a trick width direction, and forming a dishing prevention portion at a position farther than said magnetic layer from the position which becomes the medium opposed surface in both sides or either side along the track width direction of said magnetic layer, in each thin-film magnetic head pattern;
forming a nonmagnetic insulating layer so as to cover said magnetic layer and said dishing prevention portion; and
planarizing and polishing said magnetic layer, said dishing prevention portion, and said nonmagnetic insulating layer thereafter.

2. The manufacturing method as claimed in claim 1, wherein said magnetic layer and said dishing prevention portion are formed of a same magnetic material.

3. The manufacturing method as claimed in claim 1, wherein said manufacturing method of the thin-film magnetic head comprising the read head portion which has a plurality of pairs of a lower shield and an upper shield functioning as the magnetic shield and the write head portion which is formed above said read head portion and has a plurality of pairs of a lower magnetic pole layer and an upper magnetic pole layer functioning as a magnetic pole comprises a step of:
forming said dishing prevention portion at the position farther than said plurality of lower shields from the position which becomes the medium opposed surface in both sides or either side along the track width direction of said plurality of lower shields in the case of forming at least a plurality of lower shields among a plurality of lower shields, a plurality of upper shields, and a plurality of lower magnetic pole layers.

4. The manufacturing method as claimed in claim 3, wherein said plurality of lower shields and said dishing prevention portion are formed of sendust, permalloy, or CoZrTa, and said nonmagnetic insulating layer is formed of alumina, and said plurality of lower shields, said dishing prevention portion and said nonmagnetic insulating layer are polished and planarized by a chemical mechanical polishing.

5. The manufacturing method as claimed in claim 3, wherein at least one electrode is formed immediately above said dishing prevention portion.

6. The manufacturing method as claimed in claim 3, wherein said dishing prevention portion is formed by sequentially stacking a plurality of dishing prevention layers via or not via the nonmagnetic insulating layer.

7. The manufacturing method as claimed in claim 6, wherein each of said plurality of dishing prevention layers is formed of a plurality of dishing prevention layer portions and the electrode is formed immediately above each of said plurality of dishing prevention layer portions.

8. A thin-file magnetic head comprising a read head portion which has a plurality of pairs of a lower shield and an upper shield functioning as a magnetic shield and a write head portion which is formed above said read head portion and has a plurality of pairs of a lower magnetic pole layer and an upper magnetic pole layer functioning as a magnetic pole, wherein
a dishing prevention portion is provided at the position farther than said plurality of lower shields from a position which becomes a medium opposed surface in both sides or either side along the track width direction of at least a plurality of lower shields among a plurality of lower shields, a plurality of upper shields, and a plurality of lower magnetic pole layers, and
at least one electrode is provided immediately above said dishing prevention portion via an overcoat layer.

9. The thin-file magnetic head as claimed in claim 8, wherein an upper surface of said at least one electrode is substantially parallel to an element formation surface of a head substrate.

10. The thin-file magnetic head as claimed in claim 8, wherein said at least a plurality of lower shields and said dishing prevention portion are formed of a same magnetic material.

11. The thin-file magnetic head as claimed in claim 10, wherein said at least a plurality of lower shields and said dishing prevention portion are formed of sendust, permalloy, or CoZrTa, and said overcoat layer is formed of alumina.

12. The thin-file magnetic head as claimed in claim 8, wherein said dishing prevention portion consists of a plurality of dishing prevention layers sequentially stacking via or not via the overcoat layer.

13. The thin-file magnetic head as claimed in claim 12, wherein the dishing prevention portion is provided at the position farther than said lower shield, said upper shield, or said lower magnetic pole layer from the position which becomes the medium opposed surface in both sides or either side along the track width direction of each of said plurality of lower shields, said plurality of upper shields, and said plurality of lower magnetic pole layers, and the upper surface of each of said plurality of lower shields, said plurality of upper shields, and said plurality of lower magnetic pole layers, and the upper surface of said dishing prevention portion are a flat surface whose heights are same.

14. The thin-file magnetic head as claimed in claim 13, wherein each of said plurality of dishing prevention layers is formed of a plurality of dishing prevention layer portions and the electrode is formed immediately above each of said plurality of dishing prevention layer portions.

15. A magnetic tape apparatus comprising a thin-file magnetic head comprising a read head portion and a write head portion formed above said read head portion, and a magnetic tape comprising a plurality of tracks which reading and writing operation of data signals are performed by said read head portion and said write head portion, wherein
said read head portion has a plurality of pairs of a lower shield and an upper shield functioning as a magnetic shield and said write head portion has a plurality of pairs of a lower magnetic pole layer and an upper magnetic pole layer functioning as a magnetic pole,
a dishing prevention portion is formed at a position farther than said plurality of lower shields from a position which becomes a medium opposed surface in both sides or either side along the track width direction of at least a plurality of lower shields among a plurality of lower shields, a plurality of upper shields, and a plurality of lower magnetic pole layers, and
at least one electrode is formed immediately above said dishing prevention portion via an overcoat layer.
